(19) United States
(12) Patent Application Publication
(10) Pub. No.: US 2009/0205674 A1
(43) Pub. Date: Aug. 20, 2009

(54) Throwaway toothpick containing a single dose of mouthwash

(76) Inventors: Aaron Daniel Saloff, Monsey, NY (US); Avi Pollock, Monsey, NY (US)

Correspondence Address: OSTRAGER CHONG FLAHERTY & BROITMAN PC, 570 LEXINGTON AVENUE, FLOOR 17, NEW YORK, NY, 10022-6894, US

(21) Appl. No.: 12/070,306

(22) Filed: Feb. 19, 2008

(51) Int. Cl. A61C 15/02; B65D 35/56

(52) U.S. Cl. 132/329; 222/105

(57) ABSTRACT

A throwaway toothpick containing a single dose of mouthwash. The throwaway toothpick containing a single dose of mouthwash includes a toothpick portion and a mouthwash portion. The toothpick portion is throwaway. The mouthwash portion extends axially from the toothpick portion, oppositely from the toothpick portion, is one-piece with the toothpick portion, and contains a single dose of mouthwash so as to allow a user to use the toothpick portion to pick the teeth thereof, thereafter turn the throwaway toothpick containing a single dose of mouthwash around and use the single dose of mouthwash of the mouthwash portion to wash the mouth thereof, and thereafter throw the throwaway toothpick containing a single dose of mouthwash away.

### 1. BACKGROUND OF THE INVENTION

A. Field of the Invention

The embodiments of the present invention relate to a toothpick, and more particularly, the embodiments of the present invention relate to a throwaway toothpick containing a single dose of mouthwash.

B. Description of the Prior Art

Numerous innovations for toothpicks have been provided in the prior art, which will be described below in chronological order to show advancement in the art, and which are incorporated herein by reference thereto. Even though these innovations may be suitable for the specific individual purposes to which they address, however, they differ from the present invention in that they do not teach a throwaway toothpick containing a single dose of mouthwash.

(1) U.S. Pat. No. 656,479 to Schellenbach.

U.S. Pat. No. 656,479 issued to Schellenbach on Aug. 21, 1900 teaches a toothpick having a hollow tubular body, such as a quill. One end of the hollow tubular body is closed and the other end of the hollow tubular body is formed with a point for engagement with the teeth. A quantity of flavoring or medicinal substance or substances are contained within the hollow tubular body directly adjacent to the point, so that when using the toothpick on the teeth, the flavoring or medicinal substances will be brought into use.

(2) U.S. Pat. No. 719,017 to Lenhardtson.

U.S. Pat. No. 719,017 issued to Lenhardtson on Jan. 27, 1903 teaches a toothpick having a holder with a discharge duct, a handle containing a liquid reservoir, a reciprocating plunger for expelling limited quantities of the liquid through the discharge duct onto the toothpick, and a flexible sack constituting a packing for a piston and a retracting device for the piston. The handle has a cap for protecting the toothpick.

(3) U.S. Pat. No. 4,040,433 to Edison.

U.S. Pat. No. 4,040,433 issued to Edison on Aug. 9, 1977 in class 132 and subclass 89 teaches a reusable toothpick and container assembly. The assembly includes a toothpick having an elongated blade terminating at one end in a tip for removing debris from between a user's teeth, and having at the other end a cap by which the toothpick can be grasped. The container is an elongated vial for holding mouthwash into which the blade can be inserted and which can be sealed by the end cap. This provides for storage and cleansing of the toothpick between uses.

(4) U.S. Pat. No. 4,403,625 to Sanders et al.

U.S. Pat. No. 4,403,625 issued to Sanders et al. on Sep. 13, 1983 in class 132 and subclass 91 teaches a disposable buccal hygenic device. An elongated cylindrical wooden body of a generally circular cross-section is pointed at each of its ends, and is of a size that the body is comparable functionally to a conventional toothpick. The elongated body is divided transversely into two separable members of generally similar length. The first member has a reduced cross-section for a distance immediately adjacent to the transverse division. The second member has an internal cavity therein contiguous with the transverse division. The internal cavity is adapted to fit slidably over the reduced cross-section portion of the first member, and is of a depth at least equal to the distance of the reduced cross-section on the first member, so that a cavity remains when the first member is inserted fully into the second member. A strand of dental floss has one end affixed to a surface of the internal cavity not engaged by the first member and has the other end affixed to the first member internal to the elongated body. Hence, when the members are joined to form the elongated body, the strand of dental floss is stored within the cavity. On the other hand, when the members are separated, the members serve as handles to assist in proper manipulation of the dental floss about a user's teeth.

(5) U.S. Pat. No. 4,509,541 to Manciocchi, Jr.

U.S. Pat. No. 4,509,541 issued to Manciocchi, Jr. on Apr. 9, 1985 in class 132 and subclass 90 teaches an antiseptic toothpick. A case contains a hollow cylinder. The cylinder and case are threadably engaged to give controllable telescopic action. The hollow cylinder is capable of containing antiseptic liquid, and has a wick at its top. A toothpick is fastened to the inside base end of the case and extends longitudinally into and through the hollow cylinder, its liquid, and its wick. Through telescopic action, the hollow cylinder is retracted into the case, which exposes the toothpick for use. When the telescoping action is reversed, the wick may be used to clean teeth and gums with the antiseptic liquid because the toothpick is retracted.

(6) U.S. Pat. No. 4,805,646 to Shimenkov.

U.S. Pat. No. 4,805,646 issued to Shimenkov on Feb. 21, 1989 in class 132 and subclass 329 teaches a toothpick having a body part with two body portions being movable relative to one another to assume different angles. The toothpick can be filled with a substance that is then expelled by squeezing or displacing a part of it. Both ends of the toothpick can be formed as working ends with different sizes.

(7) U.S. Pat. No. Des. 358,682 to Johnson.

U.S. Pat. No. Des. 358,682 issued to Johnson on May 23, 1995 in class D28 and subclass 64 teaches the ornamental design for a nicotine-containing toothpick.

(8) U.S. Pat. No. 6,669,475 to Kandelman et al.

U.S. Pat. No. 6,669,475 issued to Kandelman et al. on Dec. 30, 2003 in class 433 and subclass 89 teaches a device for use to clean interproximal dental surfaces, subgingival areas, and periodontal pockets, and deliver a drug to these surfaces, areas, and pockets after they have been cleaned. The device has a reservoir for storing and supplying the drug. The reservoir acts as a handle and has an outlet at one extremity. The device also has a needle with an internal channel through which the drug may flow. The needle is made of three successive sections including a clipping section, a cleaning section, and an applicator section. The clipping section is connected to the outlet of the reservoir in a manner as to place the channel of the needle in open communication with the reservoir. The cleaning section has an outer scrubbing surface sized to be inserted between teeth in order to clean the interproximal dental surfaces, subgingival areas, and periodontal pockets. The applicator section projects away from the cleaning segment, in a direction opposite to the clipping section. It has a plurality of perforations allowing the drug supplied from the reservoir through the channel to be delivered to the interproximal dental surfaces, subgingival areas, and periodontal pockets after their cleaning has been completed. Inasmuch as the applicator section is separate from the cleaning section and located in a position opposite to the handle, the drug may be delivered onto the areas, surfaces, or pockets having been cleaned, while reducing the risk for this drug to be withdrawn by the scrubbing surface of the cleaning section when the same is removed from between the teeth.

(9) U.S. Pat. No. Des. 523,992 to Le.

U.S. Pat. No. Des. 523,992 issued to Le on Jun. 27, 2006 in class D28 and subclass 65 teaches the ornamental design of a toothpick.

### (10) U.S. Patent Application Publication No. 20060162732 to Winn et al.

U.S. Patent Application Publication No. 20060162732 published to Winn et al. on Jul. 27, 2006 in class 131 and subclass 271 teaches a method for making a nicotine-containing toothpick, which includes creating a solution having a predetermined concentration of nicotine. A toothpick is exposed to the solution, and the amount of solution added to the toothpick is determined. The solution may be a liquid solution or a saliva soluble powder solution. The concentration of the solution can be adjusted or multiple solutions of varying concentrations of nicotine made to create toothpicks of varying nicotine levels. Sweeteners, medicaments, breath fresheners, or dentifrices can be added to the toothpick.

It is apparent that numerous innovations for toothpicks have been provided in the prior art, which are adapted to be used. Furthermore, even though these innovations may be suitable for the specific individual purposes to which they address, however, they would not be suitable for the purposes of the embodiments of the present invention as heretofore described, namely, a throwaway toothpick containing a single dose of mouthwash.

### 2. SUMMARY OF THE INVENTION

Thus, an object of the embodiments of the present invention is to provide a throwaway toothpick containing a single dose of mouthwash, which avoids the disadvantages of the prior art.

Briefly stated, another object of the embodiments of the present invention is to provide a throwaway toothpick containing a single dose of mouthwash. The throwaway toothpick containing a single dose of mouthwash includes a toothpick portion and a mouthwash portion. The toothpick portion is throwaway. The mouthwash portion extends axially from the toothpick portion, oppositely from the toothpick portion, is one-piece with the toothpick portion, and contains a single dose of mouthwash so as to allow a user to use the toothpick portion to pick the teeth thereof, thereafter turn the throwaway toothpick containing a single dose of mouthwash around and use the single dose of mouthwash of the mouthwash portion to wash the mouth thereof, and thereafter throw the throwaway toothpick containing a single dose of mouthwash away.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic perspective view of the throwaway toothpick containing a single dose of mouthwash of the embodiments of the present invention;

FIG. 2 is a diagrammatic side elevational view taken generally in the direction of ARROW 2 in FIG. 1;

FIG. 3 is a diagrammatic top plan view taken generally in the direction of ARROW 3 in FIG. 1; and

FIG. 4 is a diagrammatic top plan view of the throwaway toothpick containing a single dose of mouthwash of the embodiments of the present invention similar to that shown in FIG. 3 but prepared for mouthwash use.

### 4. LIST OF REFERENCE NUMERALS UTILIZED IN THE DRAWING

### A. General.

10 throwaway toothpick containing single dose of mouthwash of embodiments of present invention

### B. Overall Configuration.

12 toothpick portion
14 mouthwash portion
16 single dose of mouthwash of mouthwash portion 14

### C. Specific Configuration.

18 body of mouthwash portion 14
20 proximal end of body 18 of mouthwash portion 14
22 distal end of body 18 of mouthwash portion 14
24 chamber in mouthwash portion 14
26 upper bubble of chamber 24 in mouthwash portion 14
28 lower bubble of chamber 24 in mouthwash portion 14
29 ampule of chamber 24 in mouthwash portion 14
30 rigid handle of toothpick portion 12
32 weaken lines of proximal end 20 of body 18 of mouthwash portion 14
34 free-end tab of proximal end 20 of body 18 of mouthwash portion 14
36 pick of toothpick portion 12

### 5. DETAILED DESCRIPTION OF THE PREFERRED EMBODIMENTS

### A. General.

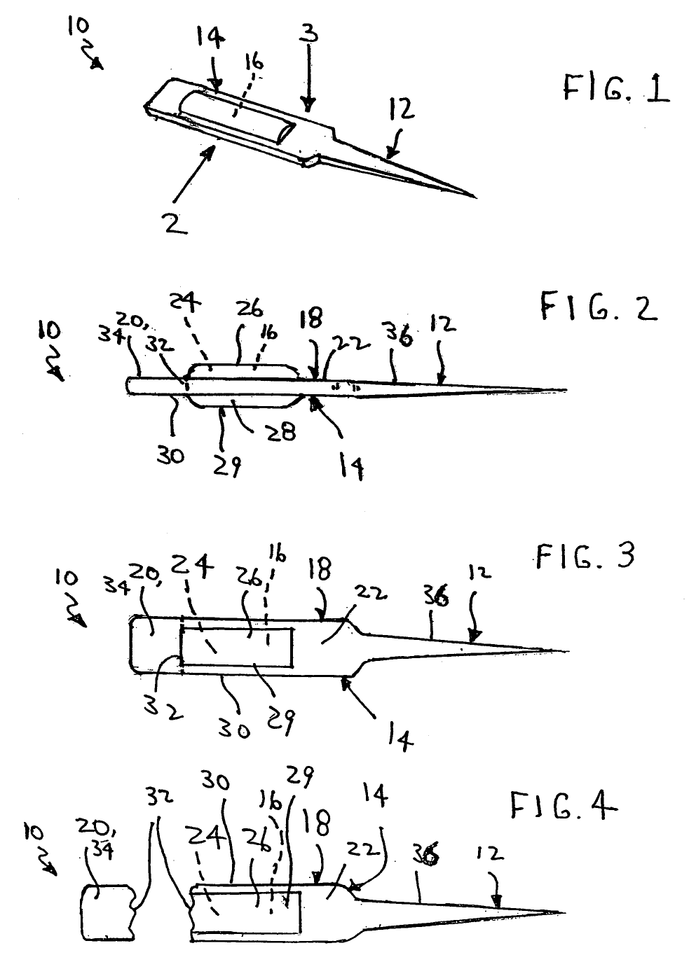

Referring now to the figures, in which like numerals indicate like parts, and particularly to FIG. 1, which is a diagrammatic perspective view of the throwaway toothpick containing a single dose of mouthwash of the embodiments of the present invention, the throwaway toothpick containing a single dose of mouthwash of the embodiments of the present invention is shown generally at 10.

### B. The Overall Configuration.

The throwaway toothpick containing a single dose of mouthwash 10 includes a toothpick portion 12 and a mouthwash portion 14. The toothpick portion 12 is for being throwaway. The mouthwash portion 14 extends axially from the toothpick portion 12, oppositely from the toothpick portion 12, is one-piece with the toothpick portion 12, and contains a single dose of mouthwash 16 so as to allow a user to use the toothpick portion 12 to pick the teeth thereof, thereafter turn the throwaway toothpick containing a single dose of mouthwash 10 around and use the single dose of mouthwash 16 of the mouthwash portion 14 to wash the mouth thereof, and thereafter throw the throwaway toothpick containing a single dose of mouthwash 10 away.

### C. The Specific Configuration.

The specific configuration of the throwaway toothpick containing a single dose of mouthwash 10 can best be seen in FIGS. 2-4, which are, respectively, a diagrammatic side elevational view taken generally in the direction of ARROW 2 in FIG. 1, a diagrammatic top plan view taken generally in the direction of ARROW 3 in FIG. 1, and a diagrammatic top plan view of the throwaway toothpick containing a single dose of mouthwash of the embodiments of the present invention similar to that shown in FIG. 3 but prepared for mouthwash use, and as such, will be discussed with reference thereto.

The mouthwash portion 14 comprises a body 18. The body 18 of the mouthwash portion 14 is rigid, flat, thin, elongated, and has a proximal end 20 and a distal end 22.

The mouthwash portion 14 contains a chamber 24. The chamber 24 in the mouthwash portion 14 is surrounded by the body 18 of the mouthwash portion 14, contains the single dose of mouthwash 16, and is defined by an upper bubble 26 and a lower bubble 28 together forming an ampule 29.

The ampule 29 of the mouthwash portion 14 is non-squeezable prior to discharge of the mouthwash 16 therefrom, by virtue of containing the single dose of mouthwash 16, and together with the body 18 of the mouthwash portion 14, form a rigid handle 30 for the toothpick portion 12.

The proximal end 20 of the body 18 of the mouthwash portion 14 is free, fluidly communicates with the chamber 24 in the mouthwash portion 14, and is defined by weaken lines 32 forming a free-end tab 34.

The ampule 29 of the mouthwash portion 14 is squeezable when the free-end tab 34 of the proximal end 20 of the body 18 of the mouthwash portion 14 is removed, by virtue of the weakened lines 32 of the proximal end 20 of the body 18 of the mouthwash portion 14, so as to allow the single dose of mouthwash 16 to be accessible for exit from the chamber 24 in the mouthwash portion 14.

The toothpick portion 12 has a pick 34. The pick 34 of the toothpick portion 12 extends taperingly and axially from the distal end 22 of the body 18 of the mouthwash portion 14.

### D. Conclusions.

It will be understood that each of the elements described above or two or more together may also find a useful application in other types of constructions differing from the types described above.

While the embodiments of the present invention have been illustrated and described as embodied in a throwaway toothpick containing a single dose of mouthwash, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A throwaway toothpick containing a single dose of mouthwash, comprising:
a) a toothpick portion; and
b) a mouthwash portion;
wherein said toothpick portion is for being throwaway;
wherein said mouthwash portion extends axially from said toothpick portion;
wherein said mouthwash portion extends oppositely from said toothpick portion; and
wherein said mouthwash portion is one-piece with said toothpick portion and contains a single dose of mouthwash so as to allow a user to use said toothpick portion to pick the teeth thereof, thereafter turn said throwaway toothpick containing a single-dose of mouthwash around-and use said-single dose of mouthwash of said mouthwash portion to wash the mouth thereof, and thereafter throw said throwaway toothpick containing a single dose of mouthwash away.

2. The throwaway of claim 1, wherein said mouthwash portion comprises a body;
wherein said body of said mouthwash portion is rigid;
wherein said body of said mouthwash portion is flat;
wherein said body of said mouthwash portion is thin;
wherein said body of said mouthwash portion is elongated;
wherein said body of said mouthwash portion has a proximal end; and
wherein said body of said mouthwash portion has a distal end.

3. The throwaway of claim 2, wherein said mouthwash portion contains a chamber;
wherein said chamber in said mouthwash portion is surrounded by said body of said mouthwash portion;
wherein said chamber in said mouthwash portion contains said single dose of mouthwash; and
wherein said chamber in said mouthwash portion is defined by an upper bubble and a lower bubble together forming an ampule.

4. The throwaway of claim 3, wherein said ampule of said mouthwash portion is non-squeezable prior to discharge of said single dose of mouthwash therefrom by virtue of containing said single dose of mouthwash; and
wherein said ampule of said mouthwash portion together with said body of said mouthwash portion form a rigid handle for said toothpick portion.

5. The throwaway of claim 3, wherein said proximal end of said body of said mouthwash portion is free;
wherein said proximal end of said body of said mouthwash portion fluidly communicates with said chamber in said mouthwash portion; and
wherein said proximal end of said body of said mouthwash portion is defined by weaken lines forming a free-end tab.

6. The throwaway of claim 5, wherein said ampule of said mouthwash portion is squeezable when said free-end tab of said proximal end of said body of said mouthwash portion is removed, by virtue of said weakened lines of said proximal end of said body of said mouthwash portion, so as to allow said single dose of mouthwash to be accessible for exit from said chamber in said mouthwash portion.

7. The throwaway of claim 2, wherein said toothpick portion has a pick;
wherein said pick of said toothpick portion extends taperingly from said distal end of said body of said mouthwash portion; and
wherein said pick of said toothpick portion extends axially from said distal end of said body of said mouthwash portion.
